(19) United States
(12) Patent Application Publication
(10) Pub. No.: US 2010/0175499 A1
(43) Pub. Date: Jul. 15, 2010

(54) VEHICLE STEERING WHEEL ASSEMBLY

(75) Inventors: Freeman Thomas, Laguna Beach, CA (US); Andrei Markevich, Aliso Viejo, CA (US); Gregory Hutting, Rancho Santa Margarita, CA (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/351,113

(22) Filed: Jan. 9, 2009

(51) Int. Cl. B62D 1/04; G05G 1/10

(52) U.S. Cl. 74/552

(57) ABSTRACT

A vehicle steering wheel assembly is provided with a fixed hub adapted to be mounted within a vehicle. A fixed ring member is mounted to the fixed hub offset from a center of the ring member. A rotating ring member is mounted to the fixed ring member and has a manual grip. The rotating ring member rotates about a center thereof. The rotating ring member is adapted to be operably connected to a steering linkage. The vehicle steering wheel assembly may be provided with an electronic motion sensor. The vehicle steering wheel assembly may be provided with a pinion and a ring gear.

### BACKGROUND

1. Technical Field

The multiple embodiments disclosed relate to a vehicle steering wheel assembly.

2. Background Art

Vehicles typically have a steering wheel assembly to manually control a steering operation for the vehicle. The conventional steering wheel assemblies are mounted on a dashboard of a vehicle interior in from of an instrument panel. The steering wheel assemblies typically have a steering column with a hub of the steering wheel connected for rotation with the steering column. An outer ring is connected to the hub with multiple spokes and the hub in provided in the center of the outer ring. Often, two or more spokes are utilized to connect the hub with the outer ring. When a driver wants to control steering, the driver turns the outer ring of the steering wheel assembly. Since the outer ring is connected to the hub via the spokes, rotation of the outer ring causes rotates the hub and a shaft connected to the hub. The shaft is connected to a steering linkage, which adjusts an angular position of the vehicle wheels in order to control the steering.

Conventional steering wheels obfuscate the instrument panel because of the centrally located hub and the spokes connecting the hub to the outer ring. Instrument panels are designed to be viewed by a driver over and/or around the hub and spokes of the steering wheel assembly.

In an automotive vehicle, an airbag is often mounted to the hub under a protective outer layer. The airbag, when mounted on the hub, is a driver restraint having a flexible envelope that rapidly inflates during an impact condition in order to prevent the driver from striking the steering wheel assembly. Under normal driving conditions, the steering wheel assembly is not deployed. As the outer ring and hub are rotated by the driver to control steering during the normal driving conditions, the airbag is rotated since the airbag is mounted to the hub.

### SUMMARY

In at least one embodiment, a vehicle steering wheel assembly is provided with a fixed hub adapted to be mounted within a vehicle. A fixed ring member is mounted to the fixed hub offset from a center of the ring member. A rotating ring member is mounted to the fixed ring member and has a manual grip. The rotating ring member rotates about a center thereof. The rotating ring member is adapted to be operably connected to a steering linkage.

In a further embodiment, an electronic motion sensor is provided within one of the fixed ring member and the rotating ring member. The electronic motion sensor provides an output to a steering control in response sensing rotation of the rotating ring member relative to the fixed ring member to control the steering linkage.

In a further embodiment, the electronic motion sensor further comprises a potentiometer.

In another further embodiment, a pinion is provided within the fixed hub and having a rotational output operably connected to the steering linkage. The rotating ring member further comprises a ring gear cooperating with the pinion. Rotation of the rotating ring member rotates the ring gear to rotate the pinion and provide the rotational output.

In yet another further embodiment, the fixed ring member is mounted to the rotating ring member proximate an inner periphery of the rotating ring member.

In another further embodiment, an airbag is mounted within the fixed hub so that the airbag does not rotate upon rotation of the rotating ring member.

In a further embodiment, the airbag is asymmetrical across a lateral axis therethrough.

In still another further embodiment, at least one shifter is mounted on the fixed hub proximate a portion of the rotating ring member. The at least one shifter is adapted to up-shift and down-shift a vehicle transmission.

In a further embodiment, the at least one shifter further comprises a first shifter adapted to up-shift the vehicle transmission and a second shifter adapted to down-shift the vehicle transmission.

In another further embodiment, the first shifter is provided on a first side of the fixed hub and the second shifter is provided on a second side of the fixed hub opposite the first side.

In yet another further embodiment, at least one control button provided on the rotating ring member adapted to control at least one of an audio setting and a visual display.

In another embodiment, a vehicle steering wheel assembly is provided with a fixed hub adapted to be mounted within a vehicle. A rotating ring member is supported by the fixed hub offset from a center of the rotating ring member and proximate a periphery of the rotating ring member. The rotating ring member rotates about a center thereof to facilitate control of vehicle steering. A pinion is provided within the fixed hub and has a rotational output to facilitate control of the vehicle steering. The rotating ring member further comprises a ring gear cooperating with the pinion. Rotation of the rotating ring member rotates the ring gear to rotate the pinion and provide the rotational output.

In a further embodiment, a fixed ring member is mounted to the fixed hub and to the rotating ring member. The fixed ring member covers at least a portion of the rotating ring member.

In a further embodiment, the electronic motion sensor further comprises a potentiometer.

In another further embodiment, an airbag is mounted within the fixed hub so that the airbag does not rotate upon rotation of the rotating ring member.

In yet another embodiment, a vehicle steering wheel assembly is provided with a fixed hub adapted to be mounted within a vehicle. A rotating ring member is supported by the fixed hub offset from a center of the rotating ring member and proximate a periphery of the rotating ring member. The rotating ring member rotates about a center thereof to facilitate control of vehicle steering. An electronic motion sensor is provided within the rotating ring member. The electronic motion sensor provides an output to a steering control in response to rotation of the rotating ring member relative to the fixed hub to control vehicle steering.

In a further embodiment, a fixed ring member is mounted to the fixed hub and to the rotating ring member. The fixed ring member covers at least a portion of the rotating ring member.

In another further embodiment, an airbag is mounted within the fixed hub so that the airbag does not rotate upon rotation of the rotating ring member.

In a further embodiment, the airbag is asymmetrical across a lateral axis therethrough.

In yet another further embodiment, at least one shifter is mounted on the fixed hub proximate a portion of the rotating ring member. The at least one shifter is adapted to up-shift and down-shift a vehicle transmission.

### BRIEF DESCRIPTION OF THE DRAWINGS

FIG. 1 is a front perspective view of an embodiment of a vehicle steering wheel assembly mounted within a vehicle;

FIG. 2 is another perspective view of the vehicle steering wheel assembly mounted within the vehicle of FIG. 1;

FIG. 3 is a side elevation view of the vehicle steering wheel assembly mounted within the vehicle of FIG. 1;

FIG. 4 is another perspective view of the vehicle steering wheel assembly mounted within the vehicle of FIG. 1;

FIG. 5 is a cross-sectional view of an embodiment of the vehicle steering wheel assembly of FIG. 1;

FIG. 6 is a rear schematic view of a portion of another embodiment of the vehicle steering wheel assembly of FIG. 1; and

FIG. 7 is a front perspective view of yet another embodiment of the vehicle steering wheel assembly of FIG. 1.

### DETAILED DESCRIPTION OF EMBODIMENTS

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

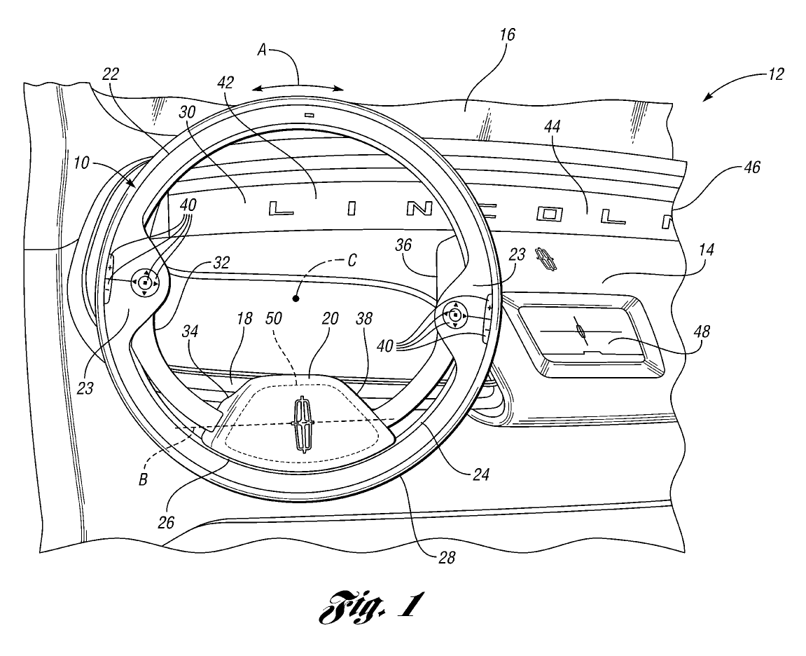

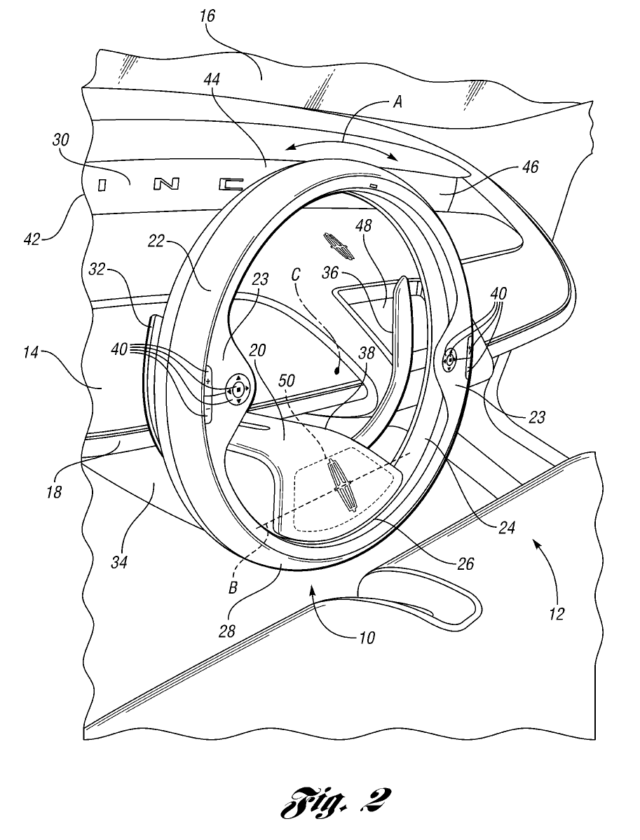

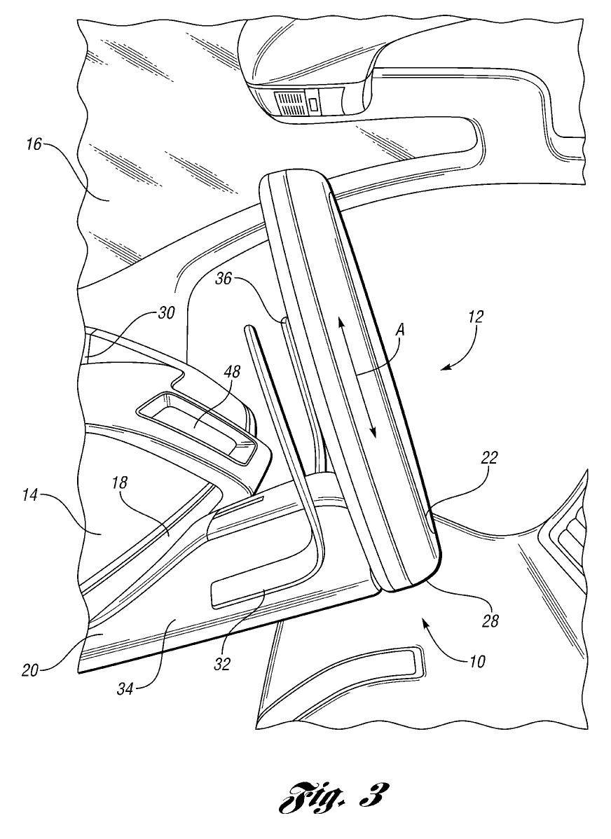

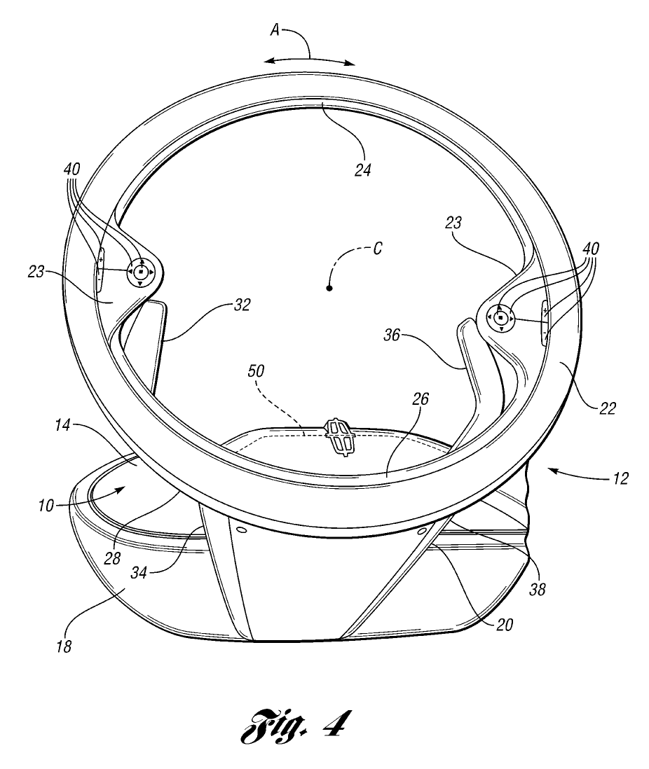

Referring to FIGS. 1-4, a vehicle wheel assembly is illustrated and generally referenced by the numeral 10. The vehicle wheel assembly 10 is provided within a vehicle interior 12 of an automotive vehicle.

As illustrated, the vehicle wheel assembly 10 is mounted to a dashboard 14 within the vehicle interior 12. The dashboard 14, as known in the art, is a control panel that may be located under a windshield of the vehicle. The dashboard 14 may have instrumentation and/or controls pertaining to operation of the vehicle.

The steering wheel assembly 10 is mounted to a steering column extending from the dashboard 14. In the depicted embodiment, the sheering wheel assembly 10 is mounted proximate a lower region 18 of the dashboard 14 so that the steering wheel assembly 10 does not obstruct a view of the driver of the dashboard 14, as discussed further below. Additionally, mounting the steering wheel assembly 10 to the lower region 18 of the dashboard 14 allows for a single steering wheel assembly 10 to be employed within various vehicles having different dashboard 10 designs without modification of the steering wheel assembly 10. Although the steering wheel assembly 10 is illustrated mounted to the lower portion 18 of the dashboard 14, any suitable location for the steering wheel assembly 10 is contemplated within the scope of the disclosed embodiments.

In the depicted embodiment, the steering wheel assembly 10 has an off-center fixed hub 20 that is mounted to the dashboard 14. The fixed hub 20 is affixed to the dashboard and does not rotate. The steering wheel assembly 10 with the off-center fixed hub 20 may be referred to as hubless because a hub and spokes do not obfuscate the driver's view of the dashboard 14.

The fixed hub 20 supports a first ring member 22. As illustrated, the first ring member 22 is a rotating ring member 22 that rotates in both directions indicated by a double-headed arrow A. In the depicted embodiment, the first ring member 22 has a center C and is supported by the fixed hub 20 offset from the center C. The rotating ring member 22 is adapted to be operably connected to a steering linkage that directs wheels of the vehicle to control the vehicle steering, as discussed further below.

The rotating ring member 22 has manual grips 23 provided on opposite sides of the rotating ring member 22. The manual grip 23 may be provided along a portion of the rotating ring member 22 or on a majority of the rotating ring member 22, as desired. In one embodiment, the grip 23 is ergonomically shaped for comfort of the driver. Any suitable grip 23 is contemplated within the scope of the disclosed embodiments.

A second ring member 24 is supported by the fixed hub 20. In the illustrated embodiment, the second ring member 24 is a fixed ring member 24 and the first ring member 22 is the rotating ring member 22. As depicted, the rotating ring member 22 is mounted to the fixed ring member 24, allowing rotation of the rotating ring member 22 while the fixed ring member 24 remains stationary, as discussed further below.

In at least one embodiment depicted in FIGS. 1-4, the rotating ring member 22 is mounted to the fixed ring member 24 proximate an inner periphery 26 of the rotating ring member 22. In another embodiment, the rotating ring member 22 is mounted to the fixed hub 20 proximate an outer periphery 28 of the rotating ring member 22.

The fixed ring member 24 is mounted the fixed hub 20 without implementing spokes, as in the prior art. Prior art steering wheel assemblies typically have a center hub connected to a ring with spokes. The center hub and the spokes obfuscate the view of the driver of the dashboard. In the steering wheel assembly 10 illustrated, the driver can view an instrument panel 30 on the dashboard 10 without obstruction from spokes. Of course, any suitable mounting of the fixed ring member 24 and to the fixed hub 20 that is offset from the center C of the ring member 24 and that does not employ spokes is contemplated within the scope of the disclosed embodiments.

In the depicted embodiment, a first shifter 32 is mounted on a first side 34 of the fixed hub 20. The first shifter 32 extends from the fixed hub 20 towards the rotating ring member 22. As depicted, the first shifter 32 extends along a portion of the rotating ring member 22 proximate to the rotating ring member 22.

A second shifter 36 may be mounted on a second side 38 of the fixed hub 20 opposite to the first side 34. The second shifter 36 extends from the fixed hub 20 towards the rotating ring member 22. As depicted, the second shifter 36 extends along a portion of the rotating ring member 22 proximate to the rotating ring member 22.

In at least one embodiment, the first shifter 32 and the second shifter 36 are mirror images of one another. The first shifter 32 may up-shift and/or down-shift for a vehicle transmission. The second shifter 36 may up-shift and/or down-shift a vehicle transmission, as known in the art. Although a first shifter 32 and a second shifter 36 are illustrated, the invention contemplates an alternate embodiment wherein only one shifter is employed.

As shown in FIGS. 1-4, the rotating ring member 22 may have multiple control buttons 40 provided therein. The control buttons 40 may in be embedded within the rotating ring member 22. In another embodiment, the control buttons 40 are mounted to the rotating ring member 22. The control buttons 40 can control features in the instrument panel 30 and/or dashboard 12, such as but not limited to a vehicle navigation system, audio features and digital screens. Any suitable control buttons 40 are contemplated within the scope of the disclosed embodiments.

The steering wheel assembly 10 has no center hub. The glossy rotating ring member 22 rotates around the stationary chrome ring member 24 with chrome shifter paddles 32, 36 on opposite sides. Simple toggles/buttons 40 embedded into the left and right sides of the rotating ring member 22 may control a vehicle navigation system and/or other menu selections. Because the steering wheel assembly 10 has no hub in the center C, the driver has a relatively unobstructed view of the instrument panel 30.

The instrument panel 30 may be panoramic and divided into three sections. The instrument panel 30 may have a mixture of digital and analog components. A left portion 42 may have human machine interface (HMI) menus and/or driver-related information such as a speedometer or odometer. A center portion 44 may display a multi-functional screen with navigation, avatar and/or other helpful, driver-oriented options. On a right portion 46 of the instrument panel 30 may be a screen, viewable only to passengers, with activities such as Internet, movies, and/or social networking.

Additionally, the dashboard 16 may have a center HMI touch screen 48 providing a digital display. The center HMI touch screen 48 allows access to an in-car connectivity platform. The in-car connectivity platform is anchored by a voice activated technology and an evolutionary Emotive Driver Advisory System (EDAS), which uses a life-like avatar to connect the driver to all of the functionality in the vehicle.

Referring still to FIGS. 1-4, the fixed hub 20 may have an airbag 50 mounted therein. Since the airbag 50 is mounted within the fixed hub 20, rotation of the rotating ring member 22 does not rotate the airbag 50. Upon an impact condition, the airbag will deploy from the fixed hub 20 without rotation, which typically occurs with airbags on prior art steering wheels. Since deployment of the airbag 50 will take place without rotation, the airbag 50 may have an asymmetrical shape across the axis B. The airbag 50 does not have to rotate and therefore does not have to be symmetrical as prior art airbags mounted on steering wheel hubs are. The asymmetrical airbag 50 allows the airbag 50 to be designed for optimal deployment to fully protect the driver.

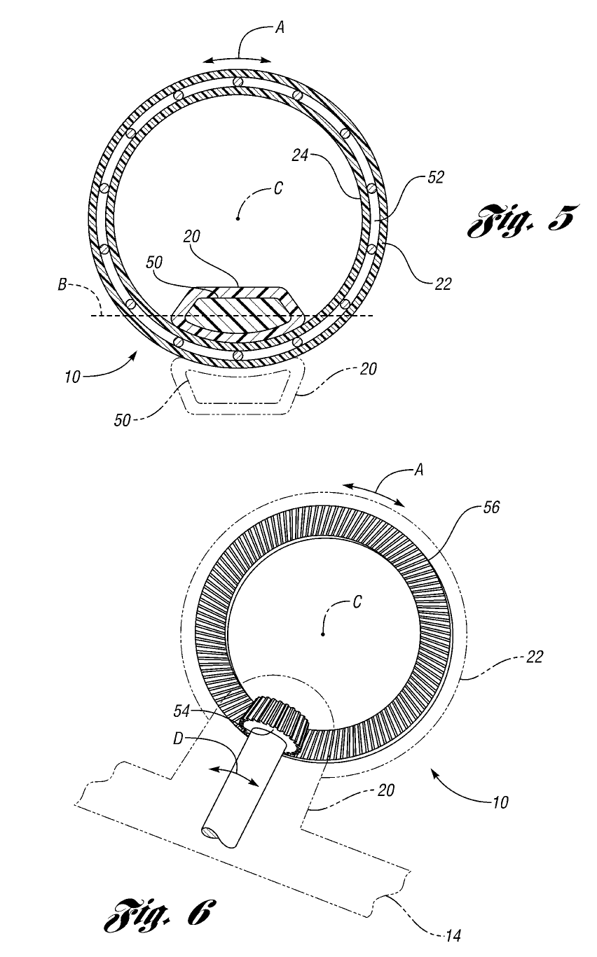

With reference now to FIG. 5, a cross-section of the vehicle steering wheel assembly 10 is illustrated. The first ring member 22 is the outer ring and is mounted on the second ring member 24 that is the inner ring. In the illustrated embodiment, the second ring member 24 is fixed and is mounted to the fixed hub 20 in any suitable known manner.

In the illustrated embodiment, the first ring member 22 is the rotating ring member 22 and the second ring member 24 is the fixed ring member 24. A bearing assembly 52 may be provided between the rotating ring member 22 and the fixed ring member 24 to allow rotation of the rotating ring member 22 in response to the driver moving the rotating ring member 22 in one of the directions indicated by arrow A. The bearing assembly 52 may be but are not limited to a roller bearing assembly and a ball bearing assembly. In another embodiment, a lubricant allows sliding between the rotating ring member 22 and the fixed ring member 24. Of course, any suitable manner of allowing relative motion between the first ring member 22 and the second ring member 24 is contemplated within the scope of the disclosed embodiments.

In at least one embodiment, the fixed hub 20 is mounted to the first ring member 22 while the second ring member 24 is mounted to the first ring member 22. The first ring member 22 would be the fixed ring member 22 while the second ring member 24 would be the rotating ring member 24.

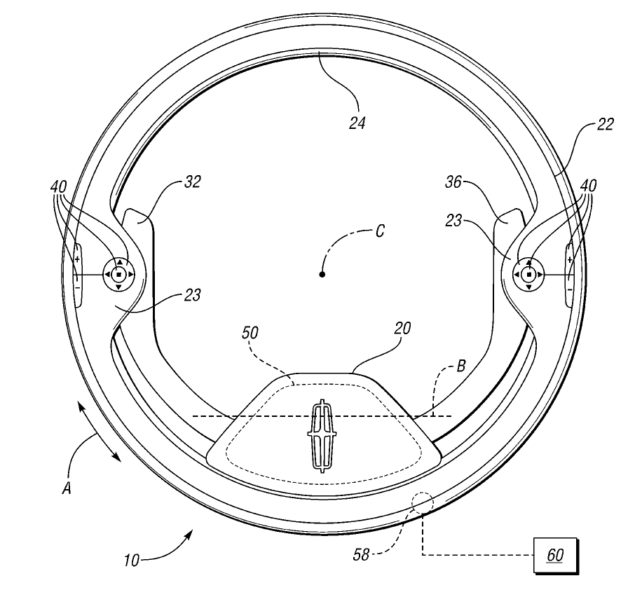

Referring now to FIG. 6, an embodiment of a portion of the vehicle steering wheel assembly 10 is depicted. A pinion 54 may be mounted within the fixed hub 20. The pinion 54 can rotate in either direction indicated by a double-headed arrow D. The pinion 54 provides a rotational output in either direction indicated by arrow D to a shaft 55 that is connected to the steering linkage to control the vehicle steering.

To rotate the pinion 54, a ring gear 56 is mounted within the rotating ring member 22. When the driver rotates the rotating ring member 22, the ring gear 56 is rotated. The ring gear 56 is engaged with the pinion 54 so that rotation of the ring gear 56 rotates the pinion 54. Although a pinion 54 and ring gear 56 are illustrated to provide the output to facilitate control of the vehicle steering, any suitable manner of controlling vehicle steering is contemplated within the scope of the disclosed embodiments.

With reference to FIG. 6, another embodiment of the vehicle sheering wheel assembly 10 is illustrated. To control vehicle steering, steer-by-wire is implemented to operably connect the vehicle steering wheel assembly to the steering linkage. An electronic motion sensor 58 is mounted within with first ring member 22, which is the rotating ring member 22. In another embodiment, the motion sensor 58 is mounted within the second ring member 24. In one embodiment, the motion sensor 58 is a potentiometer. Of course, any suitable electronic motion sensor 58 is contemplated within the scope of the disclosed embodiments.

The motion sensor 58 is employed to measure rotation between the first ring member 22 and the second ring member 24. Once the rotation is measured, the motion sensor 58 provides an output O₁ to a steering control unit 60. The steering control unit 60 receives the output O₁ from the motion sensor 58 to controls the vehicle steering.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A vehicle steering wheel assembly comprising:
a fixed hub adapted to be mounted within a vehicle;
a fixed ring member mounted to the fixed hub offset from a center of the ring member; and
a rotating ring member mounted to the fixed ring member and having a manual grip such that the rotating ring member rotates about a center thereof, the rotating ring member being adapted to be operably connected to a steering linkage.

2. The vehicle steering wheel assembly of claim 1 further comprising an electronic motion sensor provided within one of the fixed ring member and the rotating ring member such that the electronic motion sensor provides an output to a steering control in response sensing rotation of the rotating ring member relative to the fixed ring member to control the steering linkage.

3. The vehicle steering wheel assembly of claim 2 wherein the electronic motion sensor further comprises a potentiometer.

4. The vehicle steering wheel assembly of claim 1 further comprising a pinion provided within the fixed hub and having a rotational output operably connected to the steering linkage;
wherein the rotating ring member further comprises a ring gear cooperating with the pinion such that rotation of the rotating ring member rotates the ring gear to rotate the pinion and provide the rotational output.

5. The vehicle steering wheel assembly of claim 1 wherein the fixed ring member is mounted to the rotating ring member proximate an inner periphery of the rotating ring member.

6. The vehicle steering wheel assembly of claim 1 further comprising an airbag mounted within the fixed hub so that the airbag does not rotate upon rotation of the rotating ring member.

7. The vehicle steering wheel assembly of claim 6 wherein the airbag is asymmetrical across a lateral axis therethrough.

8. The vehicle steering wheel assembly of claim 1 further comprising at least one shifter mounted on the fixed hub proximate a portion of the rotating ring member, the at least one shifter being adapted to up-shift and down-shift a vehicle transmission.

9. The vehicle steering wheel assembly of claim 8 wherein the at least one shifter further comprises a first shifter adapted to up-shift the vehicle transmission and a second shifter adapted to down-shift the vehicle transmission.

10. The vehicle steering wheel assembly of claim 9 wherein the first shifter is provided on a first side of the fixed hub and the second shifter is provided on a second side of the fixed hub opposite the first side.

11. The vehicle steering wheel assembly of claim 1 further comprising at least one control button provided on the rotating ring member adapted to control at least one of an audio setting and a visual display.

12. A vehicle steering wheel assembly comprising:
a fixed hub adapted to be mounted within a vehicle;
a rotating ring member supported by the fixed hub offset from a center of the rotating ring member and proximate a periphery of the rotating ring member such that the rotating ring member rotates about a center thereof, the rotating ring member having a manual grip and being adapted to be operably connected to a steering linkage; and
an electronic motion sensor provided within the rotating ring member such that the electronic motion sensor provides an output to a steering control in response to rotation of the rotating ring member relative to the fixed hub to control the steering linkage.

13. The vehicle steering wheel assembly of claim 12 further comprising a fixed ring member mounted to the fixed hub and to the rotating ring member, the fixed ring member covering at least a portion of the rotating ring member.

14. The vehicle steering wheel assembly of claim 12 wherein the electronic motion sensor further comprises a potentiometer.

15. The vehicle steering wheel assembly of claim 12 further comprising an airbag mounted within the fixed hub so that the airbag does not rotate upon rotation of the rotating ring member.

16. A vehicle steering wheel assembly comprising:
a fixed hub adapted to be mounted within a vehicle;
a rotating ring member supported by the fixed hub offset from a center of the rotating ring member and proximate a periphery of the rotating ring member such that the rotating ring member rotates about a center thereof, the rotating ring member having a manual grip and being adapted to be operably connected to a steering linkage; and
a pinion provided within the fixed hub and having a rotational output operably connected to the steering linkage;
wherein the rotating ring member further comprises a ring gear cooperating with the pinion such that rotation of the rotating ring member rotates the ring gear to rotate the pinion and provide the rotational output.

17. The vehicle steering wheel assembly of claim 16 further comprising a fixed ring member mounted to the fixed hub and to the rotating ring member, the fixed ring member covering at least a portion of the rotating ring member.

18. The vehicle steering wheel assembly of claim 16 further comprising an airbag mounted within the fixed hub so that the airbag does not rotate upon rotation of the rotating ring member.

19. The vehicle steering wheel assembly of claim 18 wherein the airbag is asymmetrical across a lateral axis therethrough.

20. The vehicle steering wheel assembly of claim 16 further comprising at least one shifter mounted on the fixed hub proximate a portion of the rotating ring member, the at least one shifter being adapted to up-shift and down-shift a vehicle transmission.
